(19) United States
(12) Patent Application Publication
(10) Pub. No.: US 2005/0208999 A1
(43) Pub. Date: Sep. 22, 2005

(54) [GAME CONTROL SYSTEM AND ITS CONTROL METHOD]

(75) Inventors: CHIU-HAO CHENG, TAIPEI (TW); MING-KUO CHENG, TAIPEI (TW)

Correspondence Address: ZEROPLUS TECHNOLOGY CO., LTD., 2F-4, NO. 184, SEC. 4, CHUNG HSIAO EAST ROAD, TAIPEI, TW

(73) Assignee: ZEROPLUS TECHNOLOGY CO., LTD, TAIPEI HSIEN (TW)

(21) Appl. No.: 10/906,533

(22) Filed: Feb. 23, 2005

(30) Foreign Application Priority Data
Mar. 17, 2004 (TW) 093107148

(51) Int. Cl. A63F 13/00

(52) U.S. Cl. 463/37

(57) ABSTRACT

Disclosed is a game control system, which includes a main unit, and a controller for controlling the main unit to run a game software and having a camera mounted in the front side of the housing thereof and electrically connected to the circuit board inside the housing for picking up images and sending obtained images to the main unit for comparison to calculate the amount of movement of the controller relative to the main unit. Incorporating the camera into the inside of the housing of the controller saves manufacturing tools and packing materials, reduces system size and delivery cost.

This application claims the priority benefit of Taiwan patent application number 093107148 filed on Mar. 17, 2004.

### BACKGROUND OF THE INVENTION

1. Field of the Invention

2. The present invention relates generally to a game control system and more particularly, to such a game control system, which has the controller provided with a built-in camera for picking up images for calculating the amount of displacement of the controller relative to the main unit. This design of controller with built-in camera saves manufacturing tools and packing materials, and reduces system size and delivery cost.

3. Description of the Related Art.

Every video game provider keeps trying hard to create new game software to attract consumers so as to increase market share. According to an early design, the main unit of the game machine is connected to a monitor, and the controller at the main unit is used to control the game. A game machine of this design can only run a simple game software program. This design can no longer attract consumers. Nowadays, an advanced game control system uses a camera to play interesting, interactive, virtual-reality video games. The camera picks up the picture of the monitor and then sends the picture to the game machine main unit, which will in turn, calculates the data of the received picture with the control signal sent from the controller and then send the calculation result to the monitor for output. By means of this control method, the player enjoys interesting, interactive, virtual-reality video games. For playing a video game in this manner requires an external camera. When playing the game, the player may join oneself in the virtual world and become oblivious of self-existence. At this time, the player may move the body or limbs heavily, and the camera may be hit by the body or limbs of the player accidentally and forced to fall to the ground, resulting in damage of the camera. When the camera is damaged, the player shall have to stop the game and send the camera to a camera shop for repair. This problem imparts a barrier to the consumers to play this kind of game machine.

Further, it has become popular in the market to use a photographic method to control the movement of a cursor. It is worktable to combine a photographic pointer with a controller to form a multipurpose device.

### SUMMARY OF THE INVENTION

The present invention has been accomplished under the circumstances in view. It is the main object of the present invention to provide a game control system, which has the camera built-in the controller for game control, preventing damage of the camera accidentally by the user. It is another object of the present invention to provide a game control system, which has the controller and the camera use a common circuit board, thereby saving much game system manufacturing cost. It is still another object of the present invention to provide a game control system, which has the camera built-in the controller for game control, saving manufacturing tools and packing materials and reducing system size and delivery cost. It is still another object of the present invention to provide a game control system, which has the controller provided with a built-in camera for use as a pointer. To achieve these and other objects of the present invention, the game control system comprises a main unit, and a controller for controlling the main unit to run a game software. The controller comprises a housing, the housing having two handhold portions symmetrically disposed at two opposite lateral sides for the holding of the hands, a plurality of operating buttons mounted in the outside wall of the housing, a circuit board mounted inside the housing, and a camera mounted in the housing and electrically connected to the circuit board for picking up images and sending obtained images to the main unit for comparison to calculate the amount of movement of the controller relative to the main unit.

### BRIEF DESCRIPTION OF THE DRAWINGS

FIG. 1 is a perspective view of a game control system according to the first embodiment of the present invention.

FIG. 2 is a block diagram explaining the operation flow of the present invention in detection of amount of displacement of the controller in X-axis and Y-axis relative to the main unit.

FIG. 3 is a schematic drawing showing the operation of the present invention in detection of amount of displacement of the controller in X-axis and Y-axis relative to the main unit.

FIG. 4 is a block diagram explaining the operation flow of the present invention in detection of amount of displacement of the controller in Z-axis relative to the main unit.

FIG. 5 is a schematic drawing showing the operation of the present invention in detection of amount of displacement of the controller in Z-axis relative to the main unit.

FIG. 6 is a block diagram explaining the operation flow of the present invention in detection of amount of rotation of the controller relative to the main unit.

FIG. 7 is a schematic drawing showing the operation of the present invention in detection of amount of rotation of the controller relative to the main unit.

FIG. 8 is a perspective exploded view of a controller for game control system according to the second embodiment of the present invention.

FIG. 8A is a perspective assembly view of FIG. 8.

FIG. 9 is a perspective exploded and cutaway view of a controller for game control system according to the third embodiment of the present invention.

FIG. 9A is a perspective assembly view of FIG. 9.

FIG. 10 is an elevational view of a controller for game control system according to the fourth embodiment of the present invention.

### DETAILED DESCRIPTION OF THE INVENTION

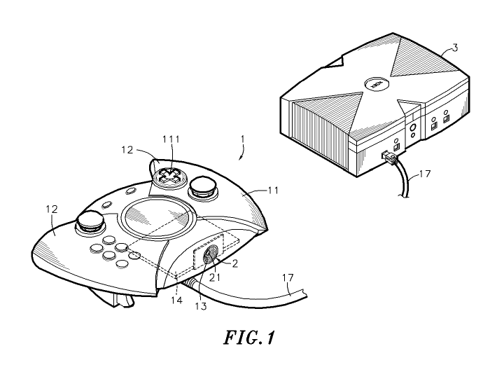

Referring to FIG. 1, a game controller 1 in accordance with a first embodiment of the present invention is shown for controlling the operation of a game machine main unit 3. According to this embodiment, the controller 1 is a palm-top joystick type game controller, and the main unit 3 is a game machine main unit controllable by the game controller 1 to run a game software. The game controller 1 comprises a housing 11, which has two handhold portions 12 symmetrically disposed at two opposite lateral sides and orthopedically engineered for the holding of the hands and a through hole 13 in the front wall thereof at the center, a plurality of operating buttons 111 mounted in the outside wall of the housing 11, a circuit board 14 mounted inside the housing 11, a signal line 17 extending out of the housing 11 and electrically connected between the circuit board 14 and the game machine main unit 3, and a camera 2 mounted inside the housing 11 and electrically connected to the circuit board 14. The camera 2 has the camera lens 21 thereof set in the through hole 13 for picking up images.

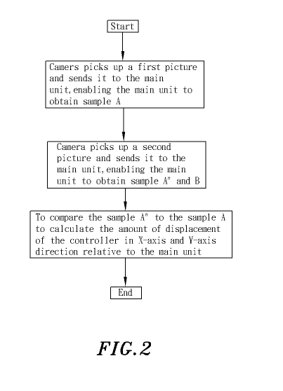

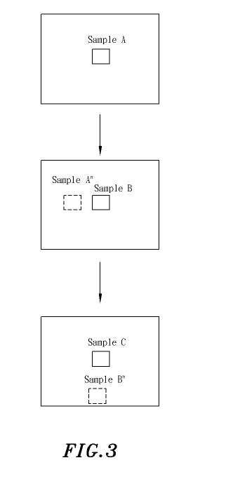

Referring to FIGS. 2 and 3 and FIG. 1 again, during the operation of the game system, the user operates the camera 2 to pick up a first picture and to send this first picture to the game machine main unit 3, enabling the internal program of the game machine main unit 3 to obtain the data of the center area of the first picture, i.e., Sample A, and then operates the camera 2 again to pick up a second picture and to send this second picture to the game machine main unit 3, enabling the internal program of the game machine main unit 3 to obtain the data of the center area of the second picture, i.e., Sample B, and the data of Sample A in Sample B, i.e., Sample A″. The internal program of the game machine main unit 3 further compares Sample A″ to Sample A to calculate the amount of displacement of the game controller 1 in X-axis and Y-axis directions relative to the game machine main unit 3.

Further, if the game machine main unit 3 receives a third picture from the camera 2, the internal program of the game machine main unit 3 will obtain the data of the center area of the third picture, i.e., Sample C, and the data of Sample B in Sample C, i.e., Sample B″. Sample B″ is further compared to Sample C to calculate the amount of displacement of the game controller 1 in X-axis and Y-axis directions relative to the game machine main unit 3.

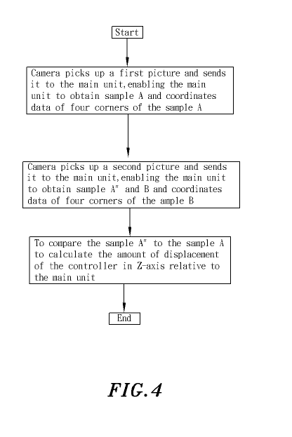

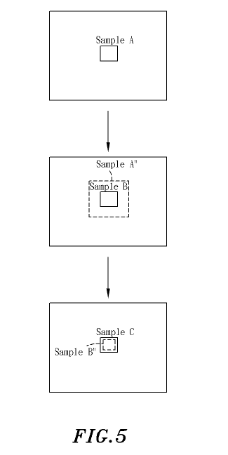

Referring to FIGS. 4 and 5 and FIG. 1 again, when detecting the amount of displacement of the game controller 1 in Z-axis direction relative to the game machine main unit 3, operate the camera 2 to pick up a first picture and to send this first picture to the game machine main unit 3, enabling the internal program of the game machine main unit 3 to obtain the data of the center area of the first picture, i.e., Sample A and to further calculate the coordinates value of the four corners of Sample A, and then operate the camera 2 again to pick up a second picture and to send this second picture to the game machine main unit 3, enabling the internal program of the game machine main unit 3 to obtain the data of the center area of the second picture, i.e., Sample B, and the data of Sample A in Sample B, i.e., Sample A″. The internal program of the game machine main unit 3 further calculates the coordinates data of the four corners of Sample A″, and then compares the coordinates data of the four corners of Sample A″ to the coordinates data of the four corners of Sample A so as to obtain the amount of displacement of the game controller 1 in Z-axis direction relative to the game machine main unit 3. Further, if the value obtained from Sample A″ surpasses the value obtained from Sample A, the displacement of the game controller 1 in Z-axis direction relative to the game machine main unit 3 is a forward movement. On the contrary, if the value obtained from Sample A″ is smaller than the value obtained from Sample A, the displacement of the game controller 1 in Z-axis direction relative to the game machine main unit 3 is a backward movement.

Further, if the game machine main unit 3 receives a third picture from the camera 2, the internal program of the game machine main unit 3 will obtain the data of the center area of the third picture, i.e., Sample C, and the data of Sample B in Sample C, i.e., Sample B″. The coordinates data of the four corners of Sample B″ is further compared to the coordinates data of the four corners of Sample B to calculate the amount of displacement of the game controller 1 in Z-axis directions relative to the game machine main unit 3.

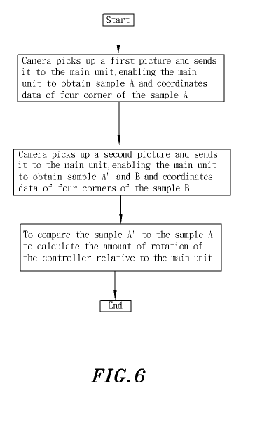

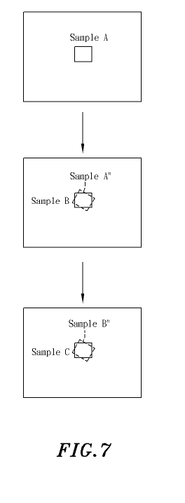

Referring to FIGS. 6 and 7 and FIG. 1 again, when detecting the amount of rotation of the game controller 1 relative to the game machine main unit 3, operate the camera 2 to pick up a first picture and to send this first picture to the game machine main unit 3, enabling the internal program of the game machine main unit 3 to obtain the data of the center area of the first picture, i.e., Sample A and to further calculate the coordinates value of the four corners of Sample A, and then operate the camera 2 again to pick up a second picture and to send this second picture to the game machine main unit 3, enabling the internal program of the game machine main unit 3 to obtain the data of the center area of the second picture, i.e., Sample B, and the data of Sample A in Sample B, i.e., Sample A″. The internal program of the game machine main unit 3 further calculates the coordinates data of the four corners of Sample A″, and then compares the coordinates data of the four corners of Sample A″ to the coordinates data of the four corners of Sample A so as to obtain the amount of rotation of the game controller 1 relative to the game machine main unit 3. Further, if the game machine main unit 3 receives a third picture from the camera 2, the internal program of the game machine main unit 3 will obtain the data of the center area of the third picture, i.e., Sample C, and the data of Sample B in Sample C, i.e., Sample B″. The coordinates data of the four corners of Sample B″ is further compared to the coordinates data of the four corners of Sample B to calculate the amount of rotation of the game controller 1 relative to the game machine main unit 3.

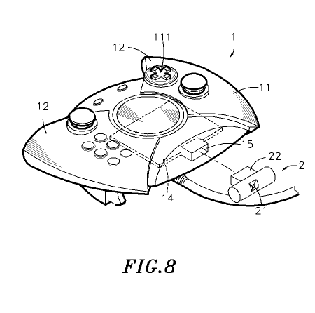

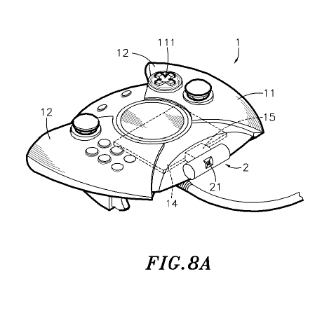

FIGS. 8 and 8A show a game controller 1 according to a second embodiment of the present invention. According to this embodiment, a socket 15 is provided in the housing 11 of the game controller 1 and electrically connected to the circuit board 14. The camera 2 has a connector 22 detachably connected to the socket 15. This detachable design allows the user to remove the camera 2 from the game controller 1 for a maintenance work.

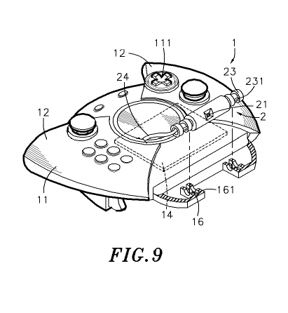

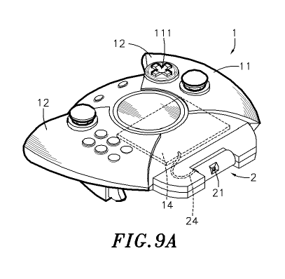

FIGS. 9 and 9A show a game controller 1 according to a third embodiment of the present invention. According to this embodiment, the housing 11 of the game controller 1 comprises two pivot holes 16 aligned in a line at the front side and two stop portions 161 respectively disposed in the pivot holes 16. The camera 2 has two pivot pins 23 respectively disposed at sides and respectively pivotally coupled to the pivot holes 16 in the housing 11 of the game controller 1, and a signal line 24 extending out of one pivot pin 23 and electrically connected to the circuit board 14 inside the housing 11. Therefore, the camera 2 can be rotated relative to the housing 11 to change the shooting angle of the camera lens 21. Further, the pivot pins 23 of the camera 2 each have a protruding stop portion 231 for acting against the stop portions 161 to limit the angle of rotation of the camera 2 relative to the housing 11.

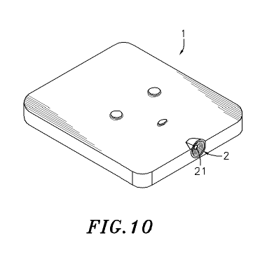

FIG. 10 shows a fourth embodiment of the present invention. According to this embodiment, the controller 1 is a remote controller for controlling the operation of a PC (personal computer) or game machine main unit.

Although particular embodiments of the invention have been described in detail for purposes of illustration, various modifications and enhancements may be made without departing from the spirit and scope of the invention. Accordingly, the invention is not to be limited except as by the appended claims.

1. A game control system comprising a main unit, and a controller for controlling said main unit to run a game software, wherein said controller comprises a housing, said housing having two handhold portions symmetrically disposed at two opposite lateral sides for the holding of the hands, a plurality of operating buttons mounted in an outside wall of said housing, a circuit board mounted inside said housing, and a camera mounted in said housing and electrically connected to said circuit board for picking up images and sending obtained images to said main unit for comparison to calculate the amount of movement of said controller relative to said main unit.

2. The game control system as claimed in claim 1, wherein said controller further comprises a socket fixedly mounted in a front side of said housing and electrically connected to said circuit board; said camera is detachably connected to said housing, having an connector connectable to said socket.

3. The game control system as claimed in claim 1, wherein said housing comprises two pivot holes aligned in a line in a front side thereof; said camera is pivotally coupled to said housing, having two pivot pins disposed at two opposite sides and respectively pivotally coupled to said pivot holes.

4. The game control system as claimed in claim 3, wherein said pivot pins of camera comprises each have a protruding stop portion adapted to limit the angle of rotation of said camera in said pivot holes relative to said housing.

5. The game control system as claimed in claim 3, wherein said housing comprises two stop portions respective disposed in said pivot holes and adapted to limit the angle of rotation of said camera in said pivot holes relative to said housing.

6. The game control system as claimed in claim 1, wherein said controller is a palm-top joystick.

7. The game control system as claimed in claim 1, wherein said controller is a remote controller.

8. The game control system as claimed in claim 1, wherein said main unit is a personal computer.

9. The game control system as claimed in claim 1, wherein said main unit is a game machine main unit.

10. A game control method used in the game control system as claimed in claim 1, the game control method comprising the step of:
(a) operating said camera to pick up a first picture and to send said first picture to said main unit;
(b) driving said main unit to calculate the data of the center area of said first picture so as to obtain Sample A;
(c) operating said camera again to pick up a second picture and to send said second picture to said main unit;
(d) driving said main unit to calculate the data of the center area of said second picture so as to obtain Sample B and to calculate the data of said Sample A in said Sample B so as to obtain Sample A″; and
(e) driving said main unit to compare said Sample A″ to said Sample A so as to calculate the amount of displacement of said controller in X-axis and Y-axis directions relative to said main unit.

11. A game control method used in the game control system as claimed in claim 1, the game control method comprising the steps of:
(a) operating said camera to pick up a first picture and to send said first picture to said main unit;
(b) driving said main unit to calculate the data of the center area of said first picture so as to obtain Sample A, and then driving said main unit to calculate the coordinates date of four corners of said Sample A;
(c) operating said camera again to pick up a second picture and to send said second picture to said main unit;
(d) driving said main unit to calculate the data of the center area of said second picture so as to obtain Sample B and to calculate the data of said Sample A in said Sample B so as to obtain Sample A″, and then driving said main unit to calculate the coordinates data of four corners of said Sample A″; and
(e) driving said main unit to compare the coordinates data of said Sample A″ to said Sample A so as to calculate the amount of displacement of said controller in Z-axis direction relative to said main unit or the amount of rotation of said controller relative to said main unit.
